(19) United States
(12) Patent Application Publication
(10) Pub. No.: US 2014/0313080 A1
(43) Pub. Date: Oct. 23, 2014

(54) MULTI-BEAM SMART ANTENNA FOR WYLAN AND PICO CELLULAR APPLICATIONS

(71) Applicant: Telefonaktiebolaget L M Ericsson, Stockholm (SE)

(72) Inventors: Roland A. Smith, Nepean (CA); Peter Frank, Stittsville (CA); Stephen Rayment, Ottawa (CA); Lot Shafai, Winnipeg (CA); Michael Skof, Nepean (CA); Jim Wight, Ottawa (CA)

(21) Appl. No.: 13/871,394

(22) Filed: Apr. 26, 2013

Related U.S. Application Data
(60) Provisional application No. 61/814,157, filed on Apr. 19, 2013.

(51) Int. Cl. H01Q 3/00

(52) U.S. Cl. CPC H01Q 3/00
USPC 342/372; 342/374; 342/368

(57) ABSTRACT

Multi-beam smart antenna for WLAN and cellular applications preferably has a steerable antenna system with a dipole antenna element located at the center of a ground plane. A first conductor is oriented parallel and collinear with a second conductor, and the ground plane is located therebetween. Each of first parasitic elements is positioned substantially parallel to the dipole element, and arranged on the upper-side of the ground plane in an array. Each of second parasitic elements is positioned parallel to the dipole element, and arranged on the underside of the ground plane in the same predetermined array. A plurality of switching elements connect parasitic elements and the ground plane to form reflective elements. Each parasitic element and corresponding parasitic element are oriented parallel and collinear with each other. A switching controller controls the switching elements to alter the antenna system's beam pattern by selectively activating or deactivating the reflective elements.

This application claims priority to U.S. provisional Patent Application No. 61/814,157, filed Apr. 19, 2013, the entire contents of which are incorporated herein by reference.

### TECHNICAL FIELD

The present invention relates to wireless communication and smart antennas. More specifically, the present invention relates to smart antennas for wireless local area network (“WLAN”), Wi-Fi, and pico-cellular wireless communications systems, including IEEE 802.11 systems.

### BACKGROUND

With the evolution of wireless networks being driven by a significant increase in wireless mobile data and the proliferation of wireless transceivers, spectrum interference is rapidly becoming the limiting factor in determining cell size and coverage.

The radio environments allocated for WLAN applications—the 2400-2500 MHz ISM band and the 5150-5350/5470-5850 MHz UNII/ISM bands—are becoming increasingly utilized, thereby raising interference levels. Furthermore, these frequency bands have defined maximum equivalent isotropic radiated power (“EIRP”) levels that, taking into account conducted power and antenna gain, define limits on the allowed transmitted power.

For Wi-Fi networks, noise from other unlicensed band systems (e.g., other Wi-Fi transceivers, Digital Enhanced Cordless Telecommunications (“DECT”) phones, Bluetooth devices, microwave ovens, and other unlicensed devices) generates a level of interference—or noise floor—which can be very large in urban areas. For example, measurements made in a typical large urban environment show noise floors in the 2.4 GHz ISM band to be in the range of −70 to −80 dBm, or approximately 20 to 30 dB above the theoretical thermal noise floor, which is −103 dBm for 20 MHz wide channels. As a result, Wi-Fi networks operating in these bands will have smaller cell sizes because the transmissions are limited by signal-to-noise ratios (“SNR”), and the Wi-Fi networks are designed to operate only to 0 dB SNR, and with maximal-ratio combining (“MRC”), they may operate with a slightly negative SNR.

Client cards, which are found in the various wireless devices, can improve performance; however, they are typically battery-powered devices with limitations on transmitted power and antenna size/gain. Similarly, because an objective of modern portable devices is to remain small while minimizing power consumption, any major improvements or enhancements in WLAN performance should preferably come from the base station or access point (“AP”). As expected, in comparison to mobile devices, size, power consumption, and cost are less of a concern to an AP.

Despite the prior attempts to improve antennas and mobile devices, a need exists for a smart antenna system, method, and apparatus to improve link budgets and reduce noise effects in a WLAN or pico-cellular network.

### SUMMARY OF THE INVENTION

The present disclosure is directed to a smart antenna and smart antenna system that may be used for WLAN applications and pico-cellular systems. The smart antenna system, which may be coupled to an AP, being capable of improving both upstream link budgets from a mobile device to an AP and downstream link budgets from the AP to the mobile device.

According to a first aspect of the present invention, a steerable antenna system comprises: a dipole antenna element located at substantially the center of a ground plane, wherein the dipole antenna element comprises a first conductor and a second conductor that is oriented parallel and collinear with the first conductor, wherein the ground plane, which has an upper-side and an underside, is located at a point between the first conductor and the second conductor; a first plurality of parasitic elements, each parasitic element positioned substantially parallel to the dipole antenna element, and arranged on the upper-side of the ground plane in a predetermined array in relation to each other and to the dipole antenna element; a second plurality of parasitic elements, each parasitic element positioned substantially parallel to the dipole antenna element, and arranged on the underside of the ground plane in substantially the same predetermined array as the first plurality of parasitic elements; a plurality of switching elements for connecting a parasitic element with a corresponding parasitic element with the ground plane to form reflective elements, wherein the parasitic element and the corresponding parasitic element are oriented parallel and collinear with each other; and a switching controller for controlling the switching elements, wherein the switching elements are used to alter the antenna system's beam pattern by selectively activating or deactivating said reflective elements.

According to a second aspect of the present invention, a system having improved signal reception comprises: a processor; data storage; a wired connection enabled to send and receive a packet; a wireless connection enabled to wirelessly send and receive a packet; a dipole antenna element located at substantially the center of a ground plane, wherein the dipole antenna element comprises a first conductor and a second conductor that is oriented parallel and collinear with the first conductor, wherein the ground plane, which has an upper-side and an underside, is located at a point between the first conductor and the second conductor; a first plurality of parasitic elements, each parasitic element positioned substantially parallel to the dipole antenna element, and arranged on the upper-side of the ground plane in a predetermined array in relation to each other and to the dipole antenna element; a second plurality of parasitic elements, each parasitic element positioned substantially parallel to the dipole antenna element, and arranged on the underside of the ground plane in substantially the same predetermined array as the first plurality of parasitic elements; a plurality of switching elements for connecting a parasitic element with a corresponding parasitic element with the ground plane to form reflective elements, wherein the parasitic element and the corresponding parasitic element are oriented parallel and collinear with each other; and a switching controller for controlling the switching elements, wherein the switching elements are used to alter the antenna system's beam pattern by selectively activating or deactivating said reflective elements.

In certain aspects, the parasitic elements may be approximately λ/4 long, ⅜λ long or λ/8 long.

In certain other aspects, the reflector elements comprise both reflectors of λ/4 length and reflectors of λ/8 length.

In yet another aspect, the plurality of parasitic elements may be arranged around the dipole antenna element to form a ring, wherein a single ring may be use or two or more stacked rings.

According to a third aspect of the present invention, a method for dynamically controlling an antenna system, said antenna system having a dipole antenna element, a first plurality of parasitic elements, a second plurality of parasitic elements, a plurality of switching elements for connecting one or more parasitic elements with the a ground plane to form a reflective elements and a switching controller for controlling said switching elements, wherein the method comprises: scanning a region by steering the antenna system's beam through multiple directions, wherein any interference on a desired channel in measured in each direction; using the measured interference to create an interference profile, wherein the interference profile is used to identify a most disruptive interference; determining the direction that corresponds to the most disruptive interference; and positioning a null in the direction of the most disruptive interference.

In certain aspects, the system may position a null in the direction of the most disruptive interference by rotating the beam pattern and/or by selectively activating one or more reflective elements.

According to a fourth aspect of the present invention, a method for controlling a beam steering antenna system, the antenna system having a dipole antenna element located substantially at the center of a ground plane, a first plurality of parasitic elements located on a first side of the ground plane, a second plurality of parasitic elements on a second side of the ground plane, a plurality of switching elements, and a switching controller, wherein the method comprises: coupling a parasitic element and a corresponding parasitic element with the ground plane using a switching element, the parasitic element and the corresponding parasitic element being oriented parallel and collinear with each other; forming a reflective element by triggering the switching element; using a switching controller to selectively control the switching elements; and steering a beam by selectively controlling the reflective elements.

According to a fifth aspect of the present invention, an steerable antenna system having improved signal reception comprises: a first steerable antenna array having both λ/4 long and λ/8 long reflectors, wherein the first steerable antenna array is operated at a frequency of about 2.4 GHz; a second steerable antenna array having both λ/4 long and λ/8 long reflectors, wherein the second steerable antenna array is operated at a frequency of about 5 GHz; and a third steerable antenna array having both λ/4 long and λ/8 long reflectors, wherein the third steerable antenna array is operated at a frequency of about 5 GHz, wherein the first antenna array is positioned between the second antenna array and the third antenna array, wherein the λ/8 reflectors do not have an effect on the 2.4 GHz signals and appear to the 5 GHz signals as λ/4 reflectors, thereby effectively hiding the λ/4 reflectors that appear as λ/2 reflectors to the 5 GHz signals

### DESCRIPTION OF THE DRAWINGS

These and other advantages of the present invention will be readily understood with reference to the following specifications and attached drawings wherein:

FIG. 1a illustrates a coordinate system for a Milne antenna;

FIG. 1b illustrates the biasing configurations for a Milne antenna;

FIG. 1c illustrates the Azimuth radiation patterns of the Milne antenna at mid-band frequency;

FIG. 2 illustrates an exemplary steerable dipole smart antenna coordinate system for an antenna array;

FIGS. 3a and 3b illustrate an exemplary multi-beam radiation pattern for 2 clients;

FIGS. 4a and 4b illustrate an exemplary multi-beam radiation pattern for 3 clients;

FIGS. 5a and 5b illustrate an exemplary multi-beam radiation pattern for 4 clients;

FIGS. 6a and 6b illustrate an exemplary multi-beam radiation pattern for 5 clients;

FIGS. 7a and 7b illustrate an exemplary multi-beam radiation configured to support two directions, at the 45 degree and 157 degree marks, with interference at 112.5 degrees;

FIG. 8 is an exemplary state diagram illustrating the various smart antenna states;

FIG. 9 is a flow chart of an exemplary ACKnowledgment transaction process between an AP and Client;

FIGS. 10a-10c illustrate exemplary antenna elements;

FIG. 11 illustrates an exemplary steerable array system having a single ring;

FIG. 12 illustrates an exemplary steerable array system having two stacked rings;

FIG. 13 illustrates an exemplary steerable array system having three sets of stacked rings;

FIG. 14 illustrates an exemplary steerable array system having λ/4 long reflectors;

FIG. 15a illustrates an access point in communication with a client device; and

FIG. 15b illustrates an access point in communication with a second access point and a client device.

### DETAILED DESCRIPTION

Preferred embodiments of the present invention will be described hereinbelow with reference to the accompanying drawings. In the following description, well-known functions or constructions are not described in detail because they may obscure the invention in unnecessary detail. The present invention relates to an innovative smart antenna system that may be coupled to, or integrated with, an AP or other communication device to enhance Wi-Fi and pico-cellular operation with multiple clients in an interference-limited environment. For this disclosure, the following terms and definitions shall apply:

The terms “IEEE 802.11” and “802.11” refer to a set of standards for implementing WLAN computer communication in the 2.4, 3.6 and 5 GHz frequency bands, the set of standards being maintained by the IEEE LAN/MAN Standards Committee (IEEE 802).

The terms “communicate” and “communicating” as used herein include both conveying data from a source to a destination, and delivering data to a communications medium, system, channel, network, device, wire, cable, fiber, circuit, and/or link to be conveyed to a destination; the term “communication” as used herein means data so conveyed or delivered. The term “communications” as used herein includes one or more of a communications medium, system, channel, network, device, wire, cable, fiber, circuit, and/or link.

The term “omnidirectional antenna” as used herein means an antenna that radiates radio wave power uniformly in all directions, with the radiated power decreasing with elevation angle above or below the plane, dropping to zero on the antenna's axis, thereby producing a doughnut-shaped radiation pattern.

The terms “directional antenna” and “beam antenna” as used herein mean an antenna that radiates greater power in one or more directions, allowing for increased performance on transmission and reception, and reduced interference from unwanted sources.

The term “processor” as used herein means processing devices, apparatus, programs, circuits, components, systems, and subsystems, whether implemented in hardware, tangibly-embodied software or both, and whether or not programmable. The term “processor” as used herein includes, but is not limited to, one or more computers, hardwired circuits, signal modifying devices and systems, devices, and machines for controlling systems, central processing units, programmable devices, and systems, field-programmable gate arrays, application-specific integrated circuits, systems on a chip, systems comprised of discrete elements and/or circuits, state machines, virtual machines, data processors, processing facilities, and combinations of any of the foregoing.

The terms “storage” and “data storage” as used herein mean one or more data storage devices, apparatus, programs, circuits, components, systems, subsystems, locations, and storage media serving to retain data, whether on a temporary or permanent basis, and to provide such retained data. The terms “storage” and “data storage” as used herein include, but are not limited to, hard disks, solid state drives, flash memory, DRAM, RAM, ROM, tape cartridges, and any other medium capable of storing computer-readable data.

The term “smart antenna” as used herein means an antenna, or antenna system, that uses one or more techniques to target clients. Such targeting techniques may include, for example: (i) beamforming and (ii) beam steering.

Regardless of the targeting technique, smart antennas are, generally speaking, antenna arrays with smart signal-processing algorithms used to identify spatial signal signatures, such as a signal's direction of arrival (“DOA”), and to calculate beamforming vectors to track and locate the antenna beam on the mobile/target. Smart antennas and/or antenna systems are often used to improve Wi-Fi and pico-cellular operation in an interference-limited environment (e.g., an environment with higher levels of interference). Therefore, an objective of such smart antenna systems is to improve the SNR a signal, thereby increasing effective data communication. As is known in the art, SNR refers to the comparison of the level of a desired signal to the level of background noise, and is defined as the ratio of signal power to the noise power. For example, an SNR value greater than 1:1 indicates that there is more signal than noise. A factor to consider is that SNR issues often arise at an AP, which is especially true for outdoor APs, where the AP is usually located high on a pole or mounted to a wall, thereby being exposed to much higher signal levels, including from interference sources.

Beamforming, a first targeting technique that may be used with 802.11 systems, refers to a method used to create a particular radiation pattern of the antenna array by adding constructively the phases of the signals in the direction of the targets/mobiles desired, and nulling the pattern of the targets/mobiles that are undesired/interfering targets. This may be accomplished using, for instance, a simple finite-impulse response (“FIR”) tapped delay line filter. Using this technique, the weights of the FIR filter may also be changed adaptively, and be used to provide optimal beamforming, in the sense that it reduces the minimum mean square error (“MMSE”) between the desired and actual beam pattern formed. In essence, using this process, a beam may be formed by modifying the phase and amplitude of the RF signals sent to the antennas. For additional information related to beamforming and beamforming techniques, see, for example, Andy Ganse's articles An Introduction to Beamforming, Applied Physics Laboratory, University of Washington, Seattle, available at http://staff.washington.edu/aganse/beamforming/beamforming.htm.

Beam steering, on the other hand, involves changing the direction of the main lobe of a radiation pattern—in effect steering the antenna's direction. Beam steering may be accomplished by switching antenna elements, changing the relative phases of the RF signals driving the elements, and/or using an electrical and/or mechanical means to point to a desired direction. For example, an exemplary beam steering method using parasitic elements is disclosed by P. K. Varlamos and C. N. Capsalis, Electronic Beam Steering Using Switched Parasitic Smart Antenna Arrays, Progress In Electromagnetics Research, PIER 36, 101-119, 2002.

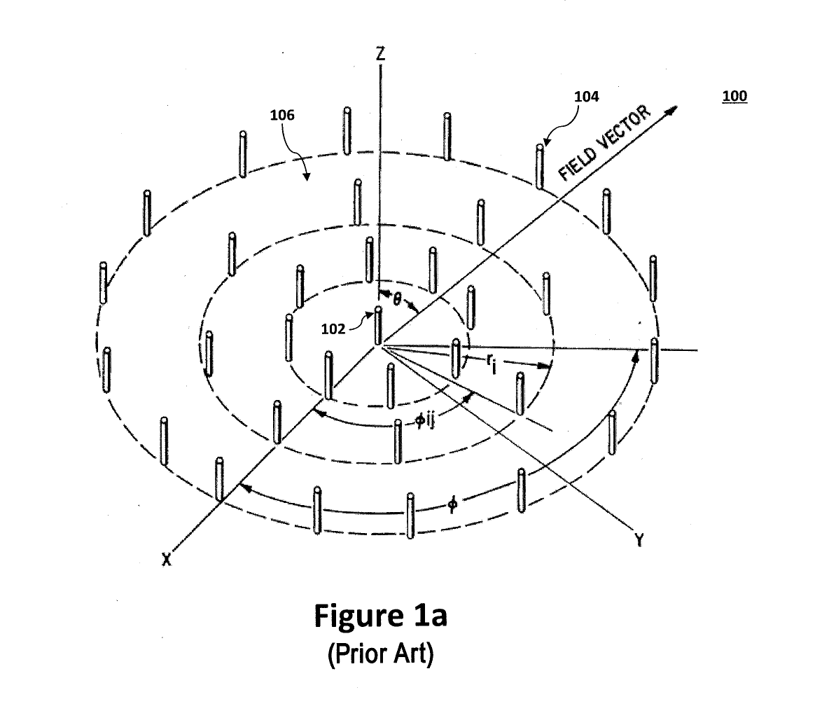

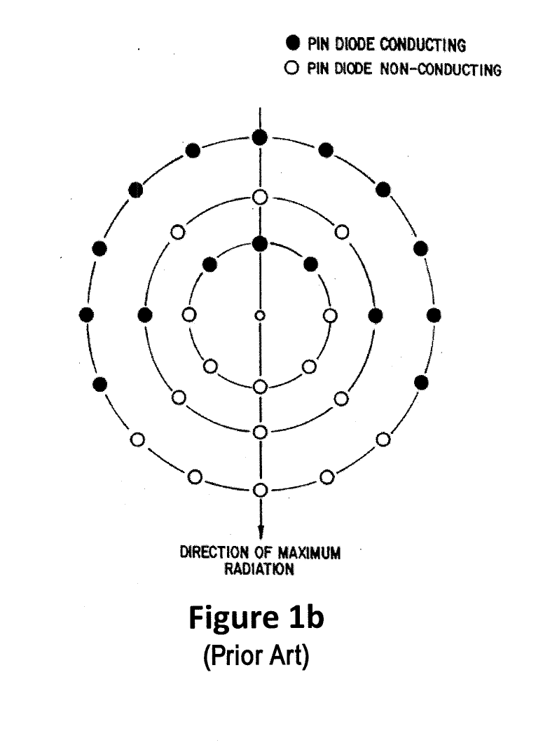

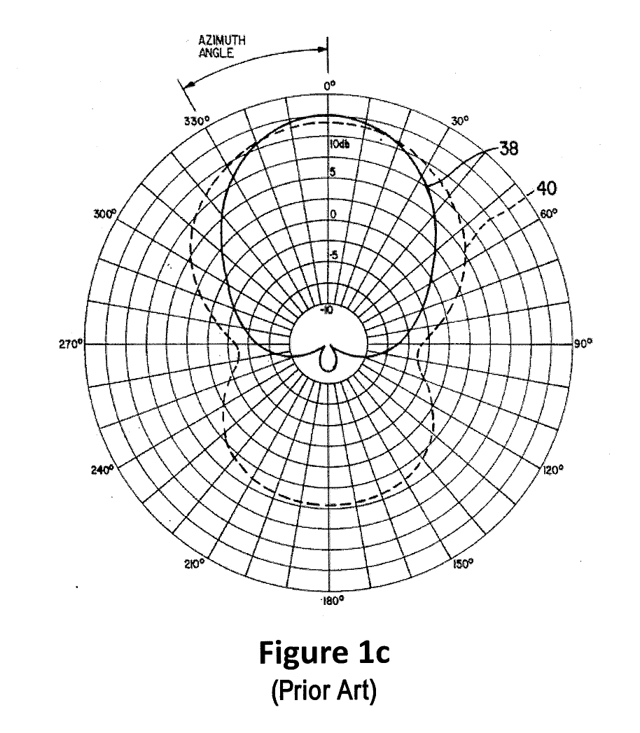

An early small linearly polarized adaptive array antenna for communication systems is disclosed by U.S. Pat. No. 4,700,197 to Robert Milne (the “Milne patent”), entitled “Adaptive Array Antenna” (the “Milne antenna”). As discussed in the Milne patent, the directivity and pointing of the Milne antenna's beam may be controlled electronically in both the azimuth and elevation planes. The Milne patent notes that the Milne antenna was found to have a low RF loss and operated over a relatively large communications bandwidth. As disclosed in the patent and illustrated in FIG. 1a, the Milne antenna 100 consists, essentially, of a driven λ/4 monopole 102 surrounded by an array of coaxial parasitic elements 104, all mounted on a ground plane 106 of finite size. The parasitic elements 104 may be connected to the ground plane 106 via PIN diodes or equivalent switching means. By applying suitable biasing voltage, the desired parasitic elements 104 could be electrically connected to the ground plane 106 and made highly reflective, thereby controlling the radiation pattern of the antenna.

While greatly improved over basic traditional antennas, the Milne antenna is still lacking in a number of ways. For instance, this type of Milne array, which consists of a series of parasitic elements connected to a single side of a ground plane, has a significant elevation tilt upwards from the ground plane and into the sky. While this configuration works well for tracking satellites, it does not work well for tracking Wi-Fi or 4G-cellular clients, which are typically at or near the ground level (e.g., ˜zero azimuth). The theory of operation for the Milne antenna is described using the coordinate system 100 illustrated in FIG. 1a. Ignoring the effects of mutual coupling and blockage between elements and the finite size of the ground plane 106, the total radiated field of the antenna array is given by Equation 1, where θ and Φ are the angular coordinates of the field point in the elevation and azimuth planes respectively. A(θ, Φ) is the field radiated by the driven element. K is the complex scattering coefficient of the parasitic element. G(θ, Φ) is the radiation pattern of the parasitic element. Fᵢⱼ(rᵢ, Φᵢⱼ, θ, Φ) is the complex function relating the amplitudes and phases of the driven and parasitic radiated fields. N is the number of rings of parasitic elements. M(i) is the number of parasitic elements in the i ring.

$$E ( θ , φ ) = A ( θ , φ ) + KG ( θ , φ ) {\sum }_{i = 1}^{N} {\sum }_{j = 1}^{M ( i )} {F}_{ij} ( {r}_{i} , {φ}_{ij} , {θ}_{j} , φ ) \qquad Equation 1$$

As evidenced in its figures, the Milne patent presents a series of parasitic element profiles, all of which are designed to maximize the theoretical gain of the antenna, or adjust the elevation beam width of the antenna. However, these Milne profiles are designed to address overhead satellites, which typically require a high azimuth gain and elevation adjustment—characteristics that are not ideal for ground level Wi-Fi or 4G-cellular clients. Milne even suggests that a practical embodiment of the invention was designed, built, and field tested for satellite-mobile communications applications at 1.5 GHz. The high azimuth gain and elevation adjustment is shown in FIGS. 1b and 1c, which are reproduced from the Milne patent. FIG. 1b illustrates a biasing configuration that generates a “low” elevation beam, while the measured low and high beam radiation patterns at mid-band frequency are shown in FIG. 1c, which illustrates the azimuth radiation patterns at mid-band frequency where the solid line is the low elevation beam measured at a constant elevation angle of 30 degrees and the broken line 40 of the high elevation beam measured at a constant elevation angle of 55 degrees.

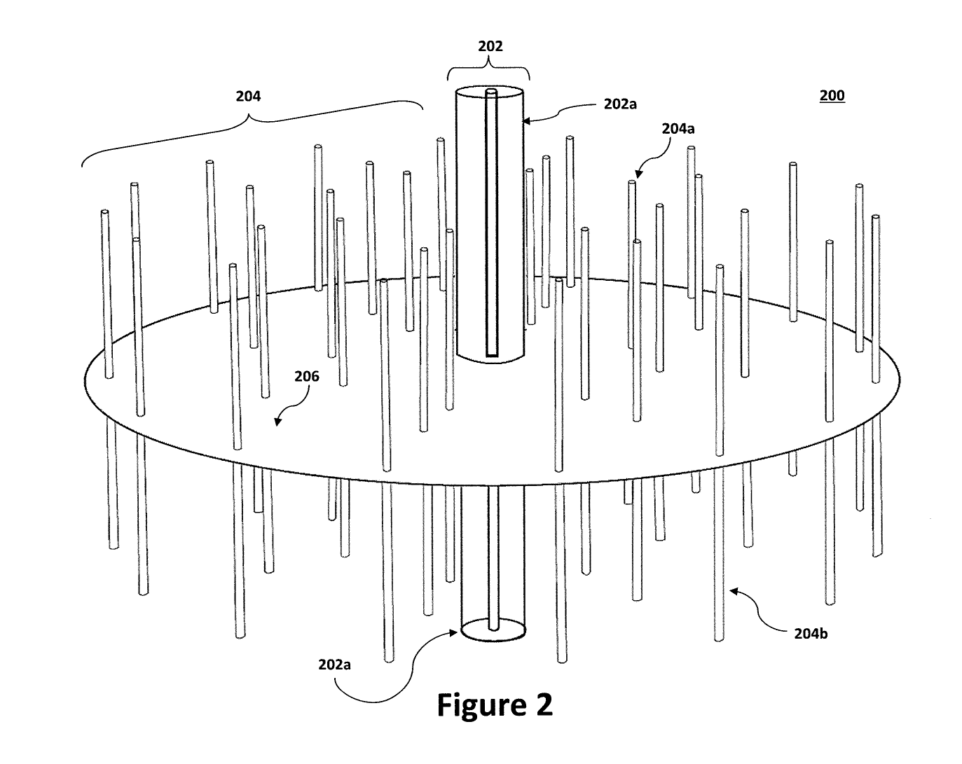

As discussed in greater detail below, and as seen in FIG. 2, the various limitations of the antenna of the Milne patent may be overcome by employing a second series of λ/4 parasitic elements that are located opposite the ground plane. Using this configuration, a λ/4 parasitic element from the first series may be connected to a corresponding (i.e., oriented parallel and collinear with each other) λ/4 parasitic element from the second series and the ground plane to form a λ/2 reflector element. Consequently, unlike the Milne antenna, which consists of a λ/4 monopole antenna, the present multi-beam antenna or antenna system may comprise a dipole antenna element. An exemplary dipole antenna coordinate system for an antenna array 200 is illustrated in FIG. 2, where the antenna, which may be enabled for multi-beam operation, yields a maximum gain at a zero azimuth to ensure maximum reach along the horizon, thereby effectively servicing Wi-Fi and/or 4G-cellular clients. In fact, employing a dipole antenna element has proven to yield higher gain than the λ/4 monopole used by the Milne patent where the ground plane reference for the monopole is limited in size.

As illustrated, the steerable antenna array 200 of FIG. 2 includes an antenna element 202 located substantially at the center of the ground plane 206, the ground plane 206 having an upper-side and an underside. Surrounding the antenna element 202 are a plurality of parasitic elements 204, each parasitic element 204 being positioned substantially parallel to the antenna element 202, and arranged in a predetermined array in relation to each other and to the antenna element 202. As illustrated, the antenna system 200 comprises a first plurality of λ/4 parasitic elements 204a located on the upper-side of the ground plane 206 and a second plurality of λ/4 parasitic elements 204b located on the underside of the ground plane 206. Upon activation, one or more λ/4 parasitic elements 204a and their corresponding λ/4 parasitic elements 204b may be electrically coupled to the ground plane 206 to yield a λ/2 reflector element (λ/4+λ/4=λ/2), wherein the ground plane is approximately mid way between the reflector's distal ends.

While the predetermined array may be substantially symmetrical as illustrated in FIG. 1b, the predetermined array may be customized for a particular application. For example, a greater number of parasitic elements 204 may be located in one location of the array to better aim the beam.

The antenna element 202 may be a dipole antenna that is center-fed driven with two rod or wire conductors 202a, 202b oriented parallel and collinear with each other (i.e., in line with each other), with a small space between them at the ground plane 206. In operation, a radio-frequency voltage may be applied to the antenna 202 at the center (e.g., at the ground plane 206), between the two conductors 202a, 202b.

A plurality of switching elements may be provided to connect one or more λ/4 parasitic elements with their corresponding λ/4 parasitic elements to form the λ/2 reflective elements wherein the reflective elements, when activated, may be electrically connected to the ground plane 206 and made highly reflective. For example, the switching element may couple parasitic element 204a and parasitic element 204b with the ground plane 206, such that parasitic element 204a and parasitic element 204b are in line with each other, thereby creating a λ/4 reflective element.

The switching elements may be controlled using a switching controller, wherein the λ/4 reflective elements are selectively activated (e.g., electrically connected to the ground plane) and/or disabled (e.g., electrically disconnected from the ground plane) to alter the antenna's beam pattern as desired by the user. The switching controller is preferably processor-controlled (e.g., via a dedicated processor or an AP's processor), and functions according to an algorithm or under other software control. The switching controlled a switching controller for controlling the switching elements, wherein the switching elements are used to alter the antenna system's beam pattern by selectively (e.g., in accordance with a known protocol) activating and/or deactivating certain reflective elements.

While the Milne patent discloses an exemplary switching element using diodes, the dipole antenna should not be limited to only those switching elements; rather, virtually any switching element may be used to activate and deactivate the reflective element such as MEMs switches. Furthermore, while a rod-shaped element 202 is shown, one of skill in the art would recognize that another antenna element may be used, such as, for example, a patch antenna. The term patch antenna (also known as a rectangular micro strip antenna) refers to a type of radio antenna with a low profile, which can be mounted on a flat surface and generally comprises a flat rectangular sheet or “patch” of metal that may be mounted over the ground plane 206.

In addition, an Alford loop antenna may be used. An Alford loop feeds two dipoles curved into a loop that radiates an omnidirectional pattern with horizontal polarization when located horizontally over a ground plane.

Furthermore, while the previous example teaches λ/4 parasitic elements 204a, 204b, the steerable antenna system 200 need not be limited to parasitic elements of length λ/4. Rather, the parasitic elements 204a, 204b, depending on the designer's needs, may be either longer or shorter (e.g., λ/8 or ⅜λ long). In fact, a single antenna system 200 may even employ two or more parasitic element lengths. Moreover, the parasitic reflectors, described above with a single switching element, may have multiple switching elements and varied lengths, all of which result in the same azimuthal directivity, but with the possibility of elevation control. As an example, a parasitic element may be ⅝λ in length, with two switching elements at length ⅛λ and 4/8λ. The four combinations of switching values (0,0), (0,1), (1,0), and (1,1) would yield variations in the elevation of the directed antenna pattern, as well as the understood variations in azimuth patterns.

In a first example, the first series of parasitic elements 204a may be ⅜λ long while the second series of parasitic elements 204b may have a length of λ/8. While the overall length of the reflective elements 204 remains λ/4, the direction of the beam is slightly elevated (but not to the extent of the Milne antenna), thereby servicing buildings with less of the beam being projected into the ground.

In a second example, in a multi-band antenna system, the reflector elements may comprise both λ/4 long and λ/8 long reflectors, which appear to the 5 GHz signals as λ/2 and λ/4 elements. For the 2.4 GHz signals, the λ/8 should not have any effect, but to the 5 GHz signals, these λ/8 reflectors appear as λ/4 reflectors, thereby effectively hiding the λ/4 reflectors, which appear as λ/2 reflectors to the 5 GHz signals.

While the previously described example teaches an antenna system 200 wherein parasitic elements 204a, 204b are concurrently electrically coupled with the ground plane 206, the parasitic elements 204a and 204b may be separately controlled depending on the user's needs. For instance, parasitic elements 204a and 204b may always be electrically isolated from one another (unless both parasitic elements 204a, 204b are activated) thereby enabling the user to independently connect just one parasitic element 204a to the ground plane 206. Thus, according to this example, it is possible for parasitic element 204a to be activated while parasitic element 204b is not activated. Utilizing independently controlled functionality may provide the user with additional elevational control over areas of the beam.

A steerable dipole smart antenna, such as the one illustrated in FIG. 2, addresses an innovative set of element profiles, thereby enabling the antenna to track multiple clients. Whereas the Milne patent only details a single high gain beam, the dipole smart antenna enables a multi-beam system capable of tracking multiple clients, providing above unit gain where unit gain is the gain of the central antenna element with all of the parasitic elements configured to be “off” or non-reflective and would appear as a toroid or “donut” shape.

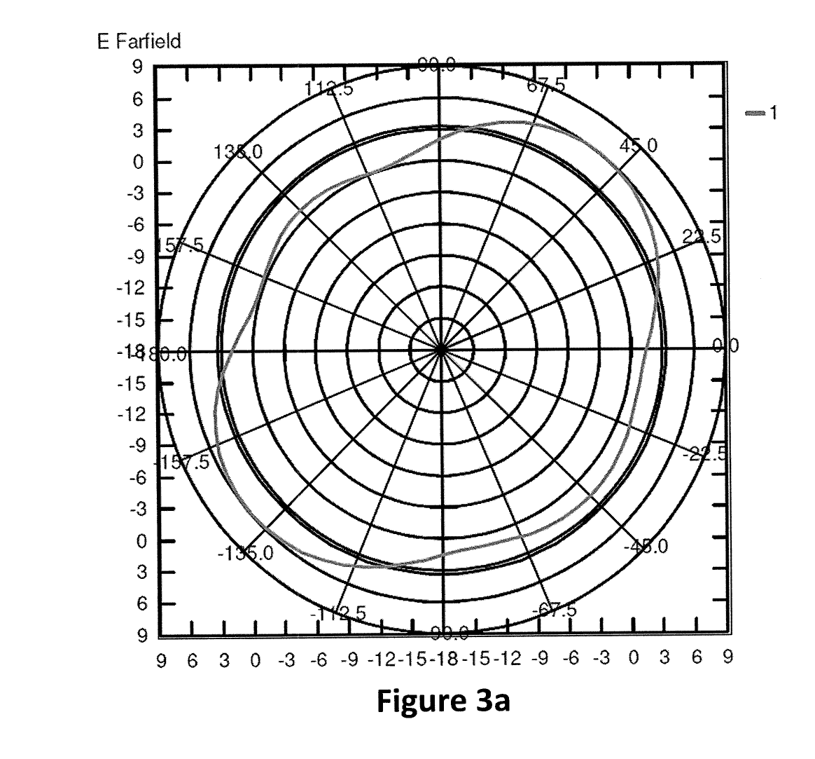

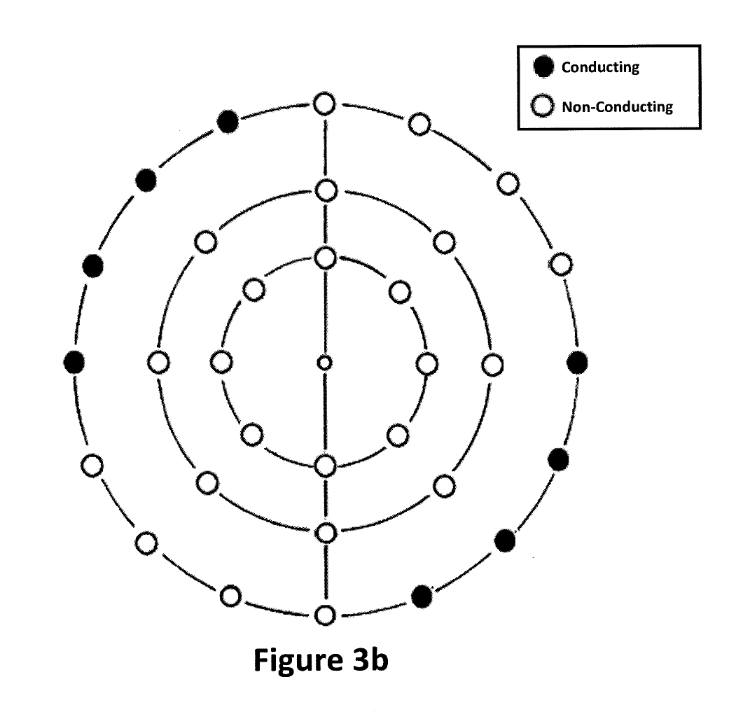

Exemplary beam patterns enabled to handle multiple clients are depicted in FIGS. 3a through 6a, along with their corresponding biasing configurations, which are depicted in FIGS. 3b through 6b. In FIGS. 3b through 6b, a solid circle represents an activated reflective element while a hollow circle represents a deactivated reflective element.

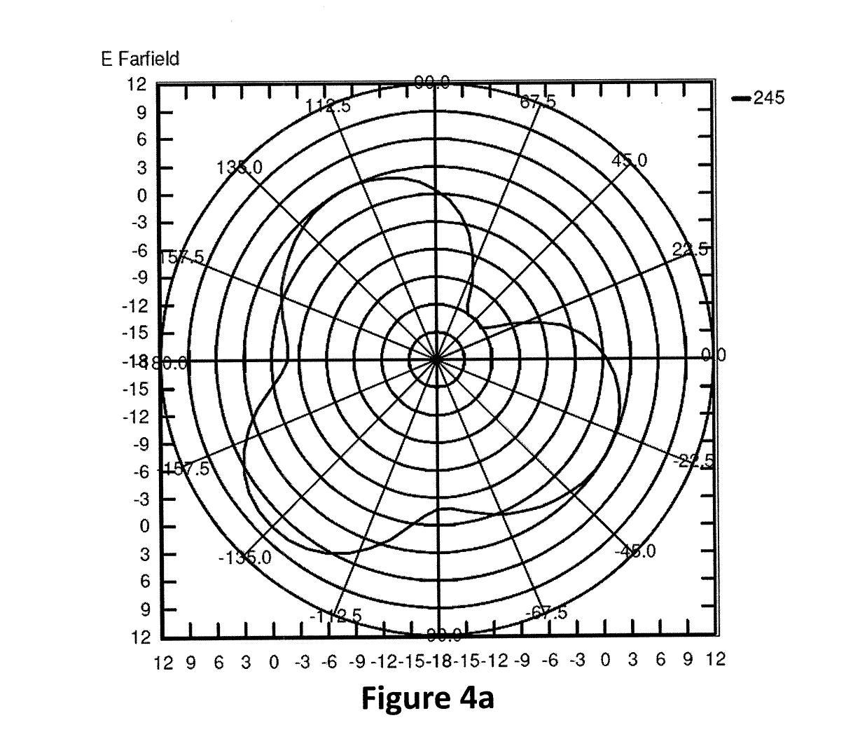

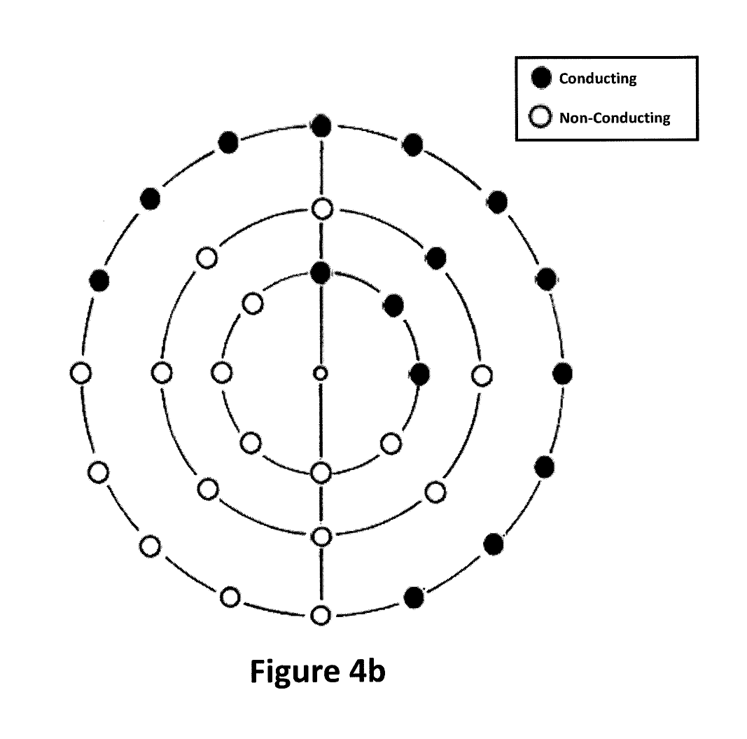

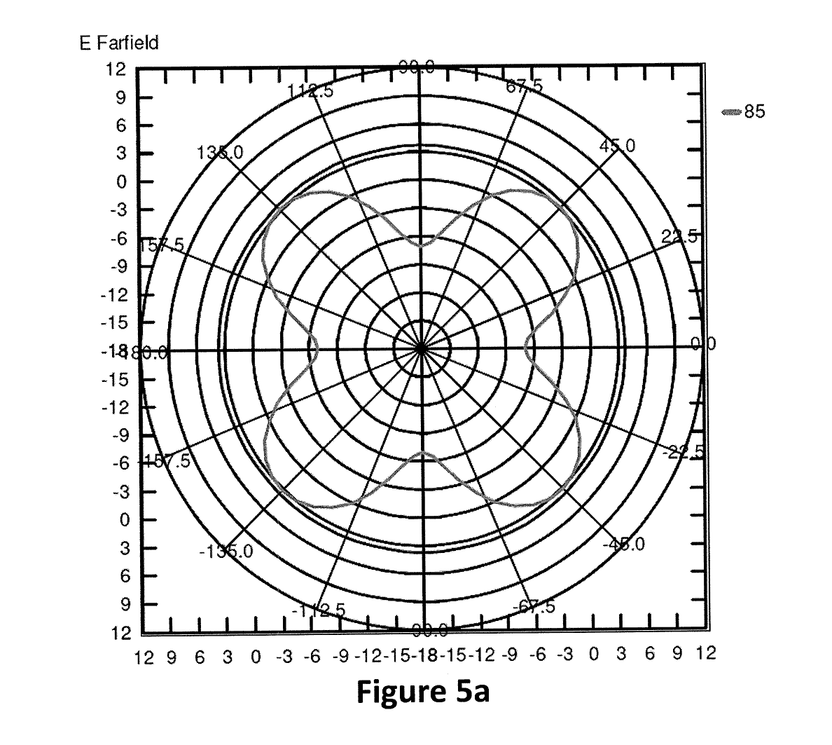

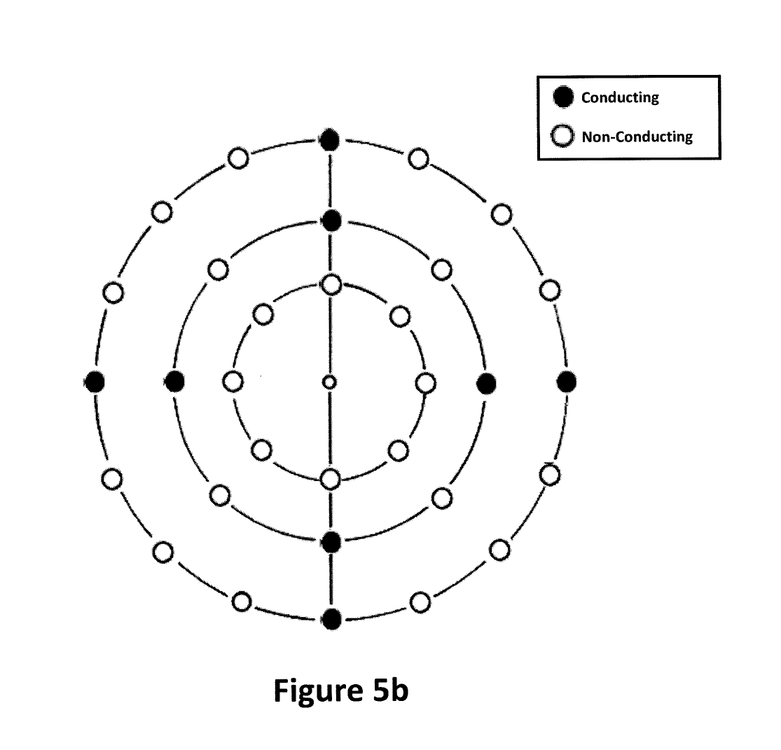

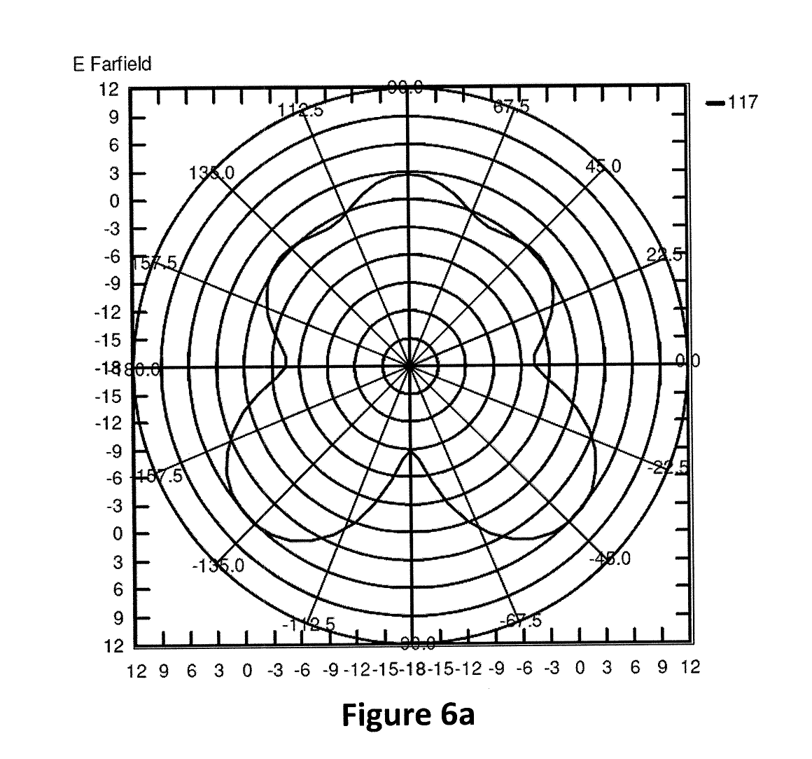

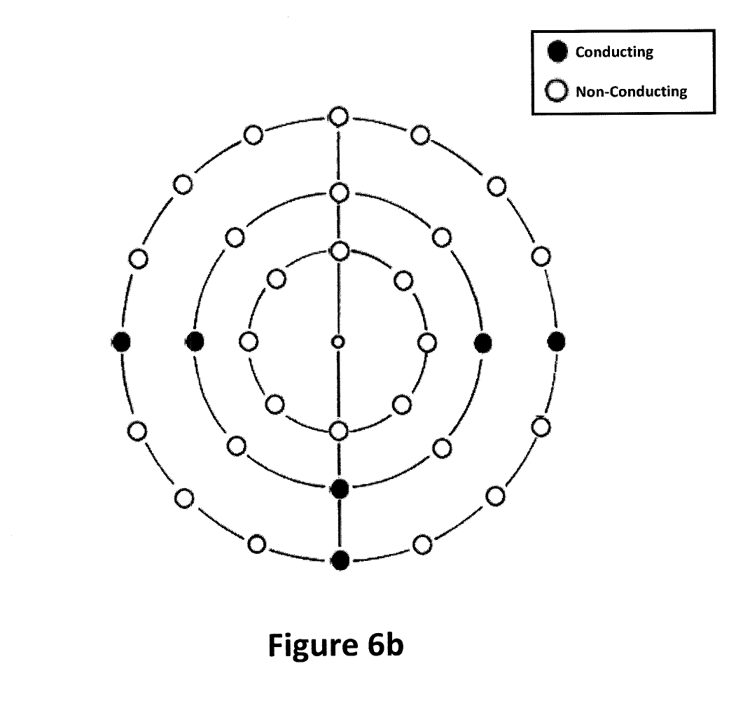

Turning back to FIGS. 3a-6a, each figure represents a pattern designed for a different number of clients where FIG. 3a illustrates a multi-beam pattern for two clients, FIG. 4a illustrates a multi-beam pattern for three clients, FIG. 5a illustrates a multi-beam pattern for four clients, and FIG. 6 illustrates a multi-beam pattern for five clients. While the patterns of FIGS. 3a through 6a represent a few of the possible patterns, one having skill in the art would be able to create countless patterns to address the desired number and location of clients (e.g., six or more clients, wherein the clients may be in various locations). Furthermore, to account for different client locations, the patterns of FIGS. 3 through 6 may be electrically rotated by physically aiming the antenna or selectively disabling/activating the reflective elements. For example, U.S. Pat. Nos. 7,973,714 and 8,059,031, entitled “Beam switching antenna system and method and apparatus for controlling the same”, both to Hyo Jin Lee, disclose a beam-switching antenna system having a conductive reflector for reflecting the beam, and a ground switch for applying a reference voltage to at least one conductive reflector to form a beam with a predetermined beam pattern by controlling the ground switch to apply the reference voltage to at least one conductive reflector.

Yet another drawback of the traditional Milne patent antenna is that it fails to address conditions where interference, or noise, is present. As explained in the Milne patent, the Milne antenna is designed for satellite communications, which deal with licensed bands and typically do not encounter interference because only a select group of users are granted access to the frequency band. On the other hand, Wi-Fi, 4G-cellular bands, and other unlicensed bands are available to a much broader audience, and thus may encounter a significant amount of interference.

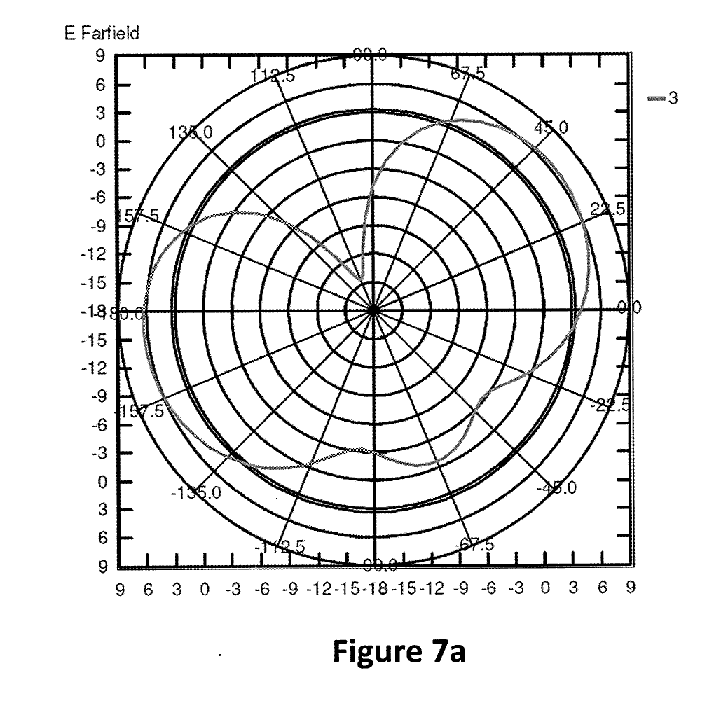

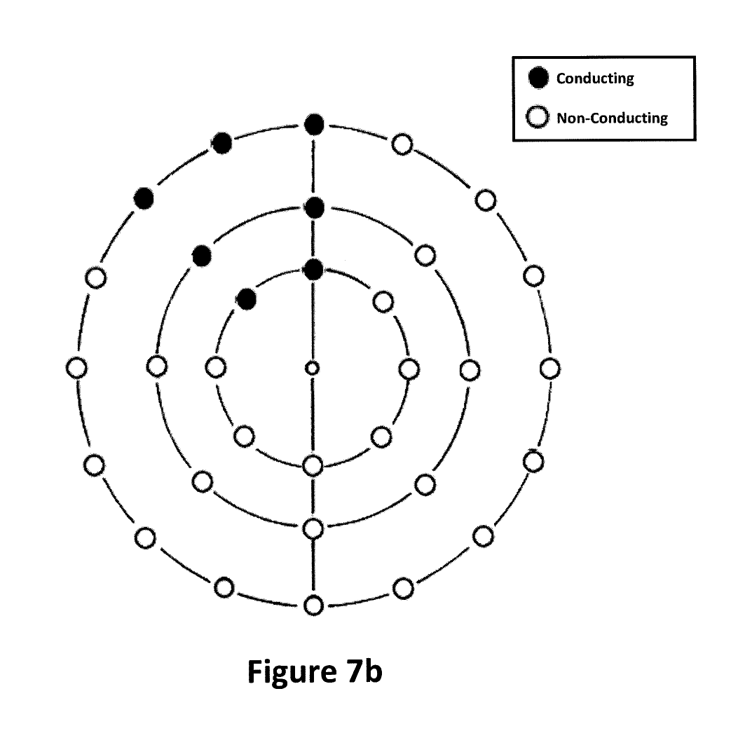

Unlike the traditional monopole Milne antenna, a dipole smart antenna system may employ interference rejection null steering techniques while maintaining multiple antenna beams to active clients within the pico-cell. This steering technique may be accomplished through, for example, a three-step process: (1) scanning the region by steering the antenna beam through all possible directions, while measuring interference on the desired channel at each direction, to create an interference profile; (2) determining which direction, or angle, contains the most disruptive interference; and (3) selecting multi-beam patterns, as required depending on client locations, to position a null in the direction of the greatest interference. Turning now to the beam pattern of FIG. 7a and its corresponding biasing configurations of FIG. 7b, the figures illustrate a multi-beam antenna enabled to support two directions (i.e., at the ˜45 degree and ˜157 degree marks), where an interference source is located at the 112.5 degree mark.

As seen in the figures, the antenna may be configured to form the beam, such that the interfering area is practically avoided via the nulling effect, thus decreasing the overall interference. If the interference source has relocated, the beam pattern may be rotated by selecting different beam patterns. For example, if the antenna system later determines that the interference is located at 67.5 degrees, the pattern may rotate about 45 degrees to support clients at the 0 and 112 degree marks.

While the previous example assumes that the interference is static, such as a microwave oven, or a fixed point-to-point (“P2P”) microwave system, the antenna may also dynamically change to address changes in the interference environment. For example, in a dynamic system, the above-mentioned three-step process may be configured to repeat at fixed time intervals to ensure that the interference profile is up-to-date. Another option would be to dynamically measure the interference level on the desired channels and rescan the region when a measure interference level increases to a predetermined threshold or deviates from a preset operating zone.

To align the dipole smart antenna, one or more algorithms may be utilized to adjust the antenna in response to SNR measurements and/or using pings. When using SNR measurements, the dipole smart antenna system may dynamically, or at set intervals, measure the SNR using any one of the techniques known in the art of signal transmission. The measured SNR value may be compared to one or more threshold SNR values to determine whether the antenna system should be adjusted. Any adjustments may be made according to a stored protocol that can be triggered when the measured SNR value deviates from a known operating range. The beam may be adjusted using the above-mentioned beamforming and beam steering techniques, or the antenna may be physically rotated using, for example, an electric motor (e.g., a step motor). For instance, in operation, if the operating SNR range is between 5× and 6×, a measured SNR value of 6.1× may trigger the antenna system to be adjusted in accordance with the stored protocol. Depending on the needs of the user, an adjustment may simply require that the antenna be rotated a certain number of degrees until the SNR is within the operating SNR range.

In addition to, or in lieu of, the SNR measurement, a ping operation may be used to detect and locate interference. The ping operation functions by sending one or more echo request packets to a target host and waiting for a response. In the ping process, the antenna system may measure the time from transmission to reception (round-trip time of the packet) and record any packet loss. The results of the test may be printed in the form of a statistical summary of the response packets received—often including the minimum, maximum, and mean round-trip times, and sometimes the standard deviation of the mean. As with the SNR technique, a protocol may be implemented that causes the antenna system to adjust the direction of the antenna when the ping returns a value (e.g., a mean round-trip time or packet loss) that deviates from a predetermined range or threshold. A basic algorithm to “steer” the antenna beam to one or more client devices would be relatively simple for someone skilled in the art to develop, and is therefore not included in this patent description. In the same way, an basic algorithm to “steer” a null so as to minimize interference to one or more client devices would be relatively simple for someone skilled in the art to develop, and is therefore not included in this patent description. In addition, a dipole smart antenna may further include algorithms for multi-beam use, which may be used with either omnidirectional or directional antennas.

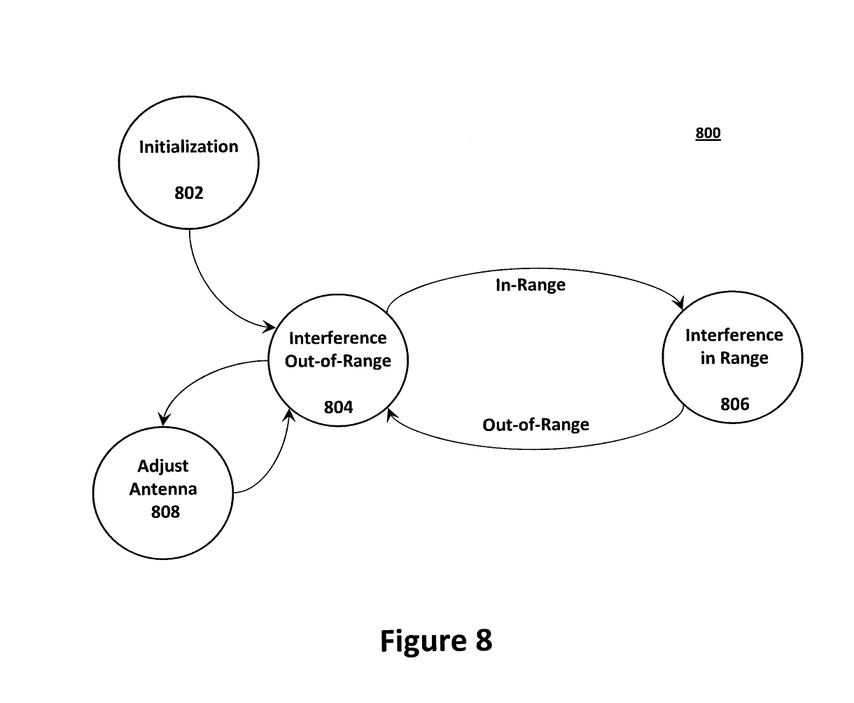

FIG. 8 illustrates an exemplary state diagram 800 of the various smart antenna system states. Once the antenna system has been initialized at 802, the antenna system (e.g., via a processor coupled with the antenna, whether dedicated or an AP processor) may automatically make a determination based on, for instance, the signal quality between the AP and client, thereby indicating whether the interference value deems that the antenna is in range 806 or out-of-range 804. If the antenna interference is out-of-range 804, indicating that the measured interference parameter (e.g., SNR or ping measurement) has deviated from a known operating range, the antenna may be adjusted 808 until the measured interference parameter is in range 806. The antenna may be adjusted 808 using any of the above-mentioned techniques, including, without limitation, beamforming, beam steering and/or physical movement of the antenna.

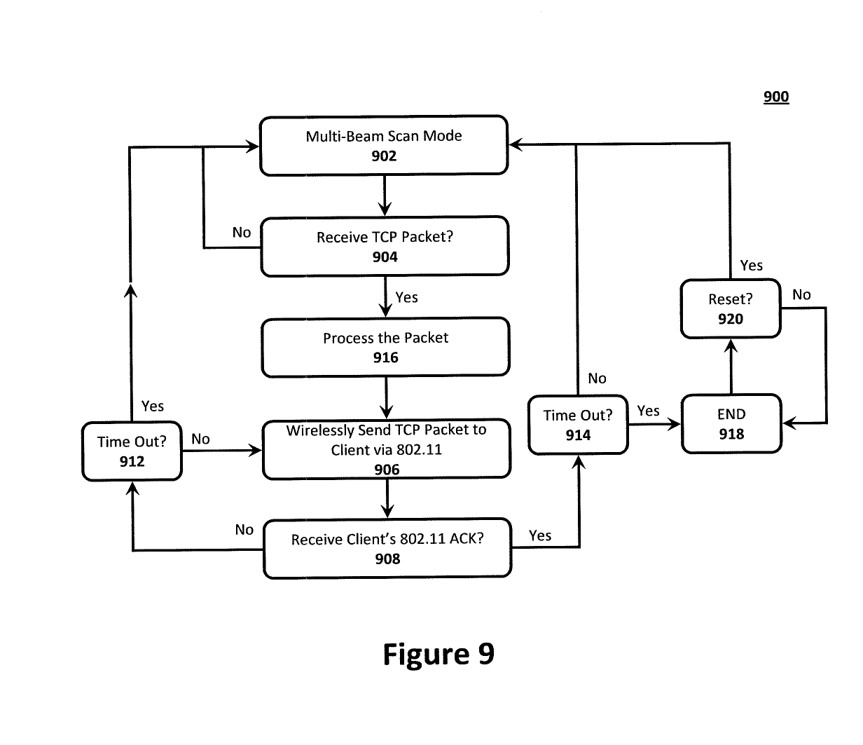

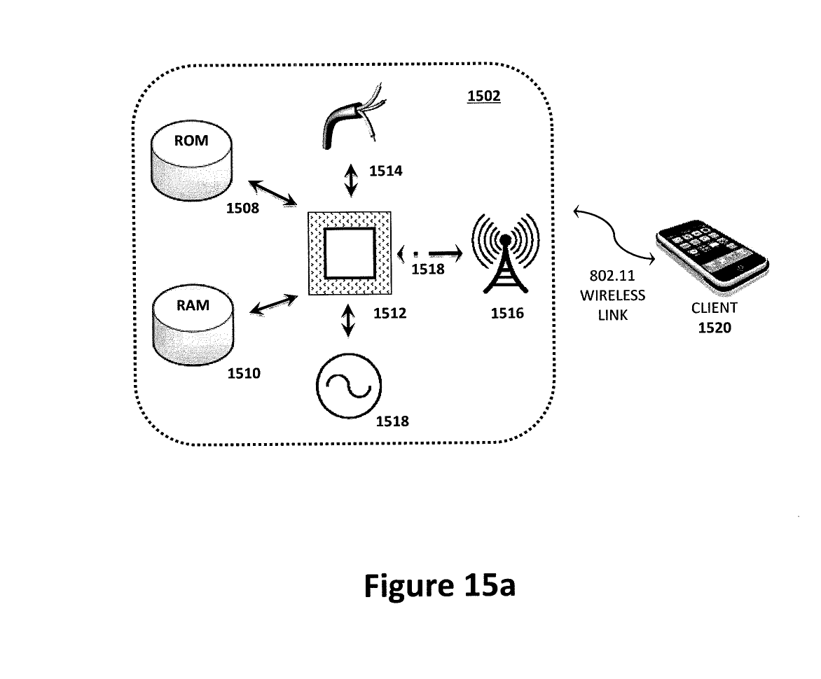

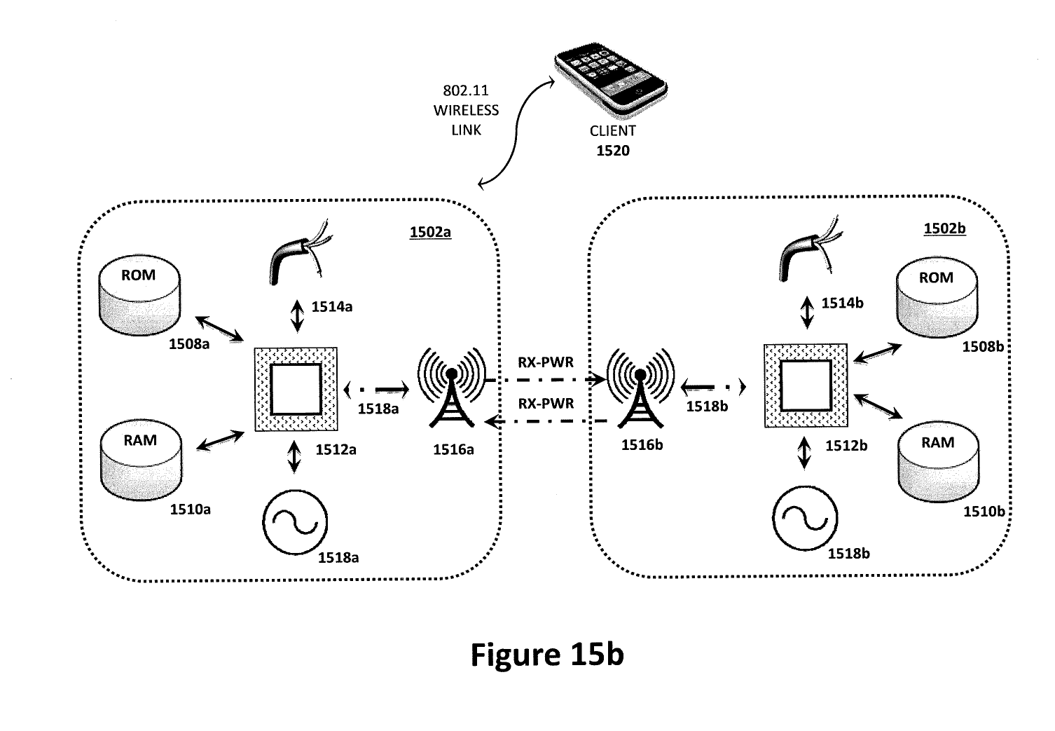

FIG. 9 is a flow chart of an exemplary ACKnowledgment transaction process 900 between an AP and a Client, where the AP delivers packets and waits for the 802.11 ACK using the higher directional gain of the smart antenna, and, once the ACK is received, the AP may return to an omnidirectional beam mode until the next packet exchange. Therefore, in general, data packets are transmitted, and associated acknowledgements are received using the multibeam antenna directionality, while management packets, such as beacons, and RTS and/or CTS CTS-TO-SELF packets are sent using the omnidirectional antenna operational mode of the smart antenna so as to address all associated clients. While the smart antenna and AP process(es) may be carried out by the processor 1512a,b of FIG. 15, one or more processes related to the smart antenna system may be performed by one or more processors associated with either an AP or a process dedicated to the smart antenna system.

The process 900 starts with the antenna in multi-beam operation at step 902. At step 904, the system (e.g., the smart antenna system or the AP) determines whether a TCP packet for transmission has been received via, for example, the TCP-relay. If a packet has not been received, the access point returns to step 902. However, if a TCP packet has been received, the access point proceeds to step 904 where the packet and/or sequence number are processed at step 916. The access point may then proceed to step 906, where the access point wirelessly sends the received TCP packet to the designated client using, for example, an 802.11 MAC/PHY wireless component coupled to a dipole smart antenna. At step 908, the system determines whether an 802.11 ACK has been received from the client in response to the transmission of the received TCP packet. Once the ACK has been received, the AP and/or smart antenna will return to multi-beam mode at step 902.

If the access point has not received the 802.11 ACK within a preset number of seconds (e.g., 1-30 seconds; more preferably, 1-15 seconds; even more preferably, 1-10 seconds; most preferably, 1-5 seconds), the system will return to step 906 and attempt to retransmit the TCP packet. This cycle may repeat until the access point has either (i) been ACKd at step 908 or (ii) a timer has signaled a “time out” flag at step 912. The timer may signal a time out flag when, for example, a preset number of transmission attempts (e.g., 1-10 attempts, more preferably, 1-5 attempts, most preferably 1-3 attempts) have been met or a preset duration of time (e.g., 1-60 seconds) has elapsed. If a time out flag is indicated at step 912, the access point returns to multi-beam scan mode at step 902. In certain embodiments, an error may be flagged at to indicate that the access point did not receive an ACK from the client acknowledging receipt of one or more packets. The errors may be recorded to, for example, a data file and/or presented to an access point user via, for example, an audio and/or visual interface or other suitable alerting mechanism.

If the access point has received the 802.11 ACK at step 908, the access point may return to multi-beam scan mode at step 902, where the process can repeat with, for instance, another data packet transmission. However, the process may be terminated if a timer has signaled a time out flag at step 914. The timer may signal a time out flag when, for example, a preset number of packets have been transmitted, a preset duration of time has elapsed, all data packets have been transmitted, and/or the process has been otherwise terminated by, for instance, a user or another system or device.

If a time out flag is indicated at step 914, the access point proceeds to the end position at step 918. The system may, however, be reset at step 920, thereby causing the access point to return to step 902. The system may be automatically reset using, for example, software, timers, and/or counters, or manually reset by a user or another system or device.

The control logic for the Smart antenna may be implemented in many different ways which are well known to those skilled in the art. In general, one would expect that a serial to parallel breakout arrangement would be required to reduce the number of control lines between the control processor and the antenna array PIN diodes. This serial to parallel arrangement can be accomplished through any one of many serial data formats such as I2C, which typically involve data and/or clocking signals. The important aspect is that the resulting parallel data bits, which would be available from, for example, a CPLD or serial shift register, would be used to control the PIN diodes of the antenna array in advance of each packet transmissions or reception. Therefore, the control of the PIN diodes must be synchronized by the control processor, to the physical layer packet transmissions/receptions.

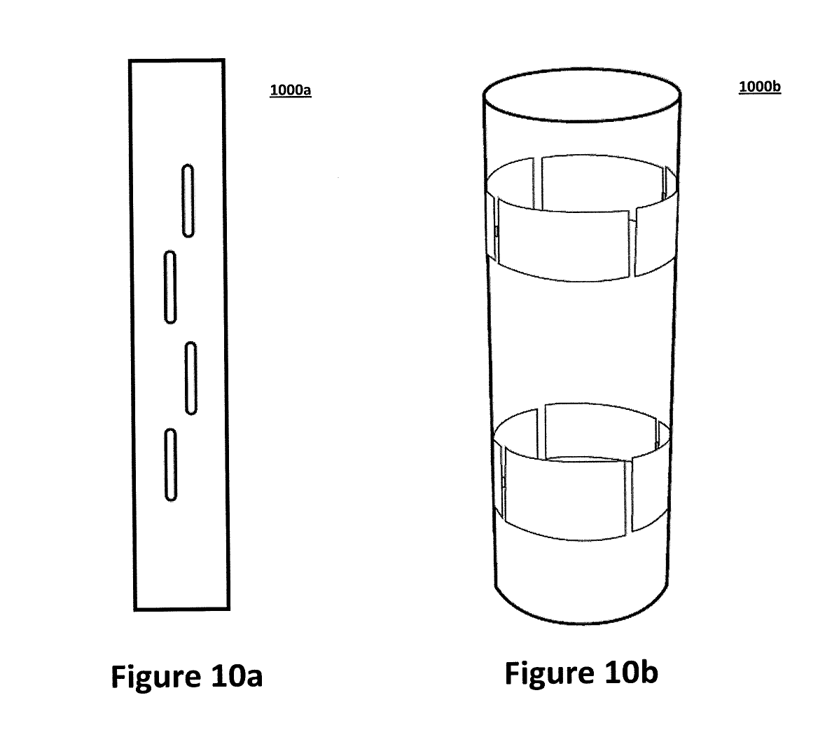

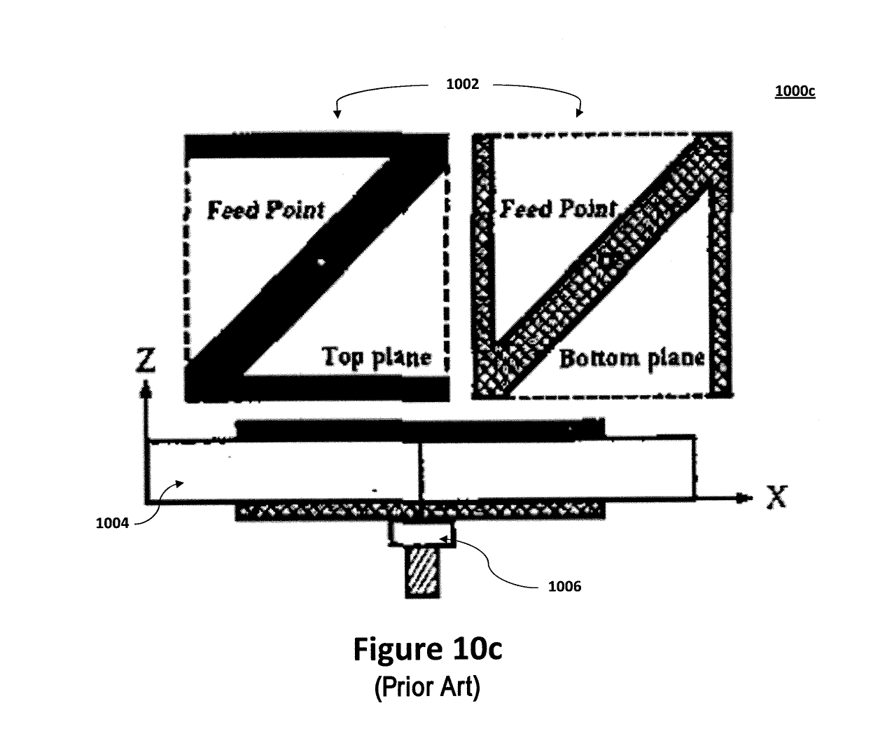

Another drawback of the Milne antenna is that the reflective elements are only vertically oriented, and thus the antenna only addresses vertically polarized elements. However, a steerable dipole connected to an AP using a SMA connector 1006. For further information related to the antenna of FIG. 10c, refer to U.S. Pat. No. 5,767,809 “OMNI-directional horizontally polarized Alford loop strip antenna.” For example, reflectors may be substantially planar 1000a, as shown in FIG. 10a, or cylindrical 100b, as shown in FIG. 10b. Alternatively, the antenna 1000c may comprise two planar components with “Z” shaped antenna elements, as illustrated in FIG. 10c.

An AP equipped with a smart antenna system may be enabled to communicate with both licensed and unlicensed access radios. For example, the BelAir100LP strand mount base station enhances signal strength via internal array beam-steering antennas and chip-based beam forming to deliver improved throughput at a greater distance and enable multiple operators to share a common wireless network infrastructure. For further information regarding the Belair 110LP and Belair's other products, refer to www.belairnetworks.com.

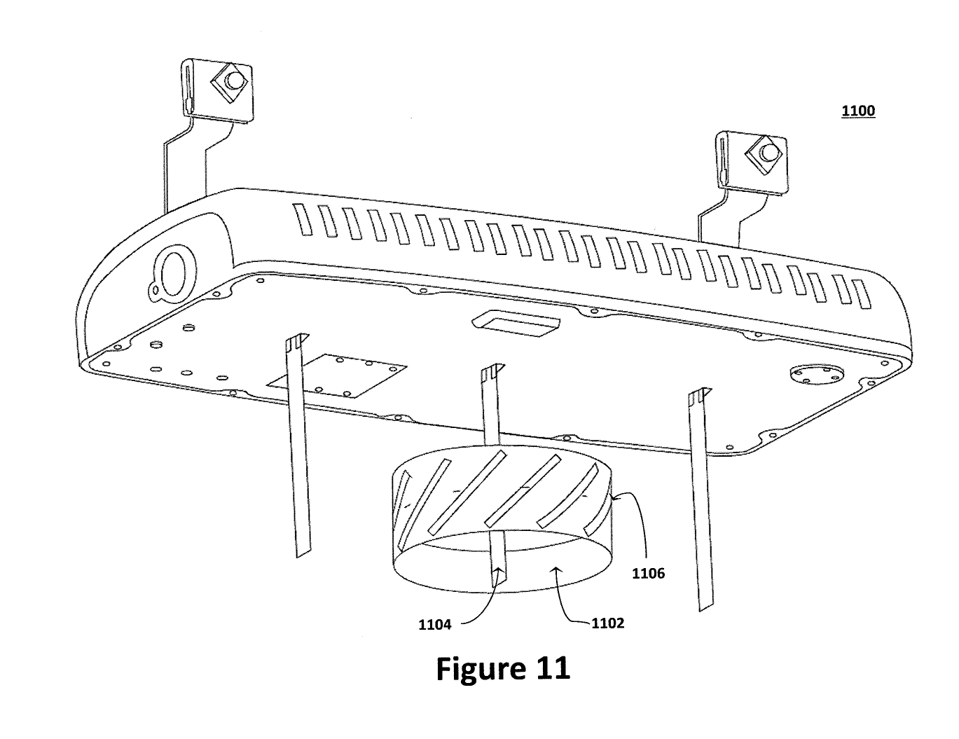

Turning now to FIGS. 11-14, four exemplary wire mount AP antenna systems are shown utilizing steerable dipole smart antenna systems. Specifically, FIG. 11 illustrates a first exemplary dipole smart antenna system 1100 having a single large cylindrical reflective element 1102 around a central antenna element 1104. As seen in the figure, the ring includes a plurality of 45 degree right-slanted reflectors 1106, which may be separately activated and/or disabled. In fact, these reflectors may be controlled in the same manner as their vertical counterparts of FIG. 2.

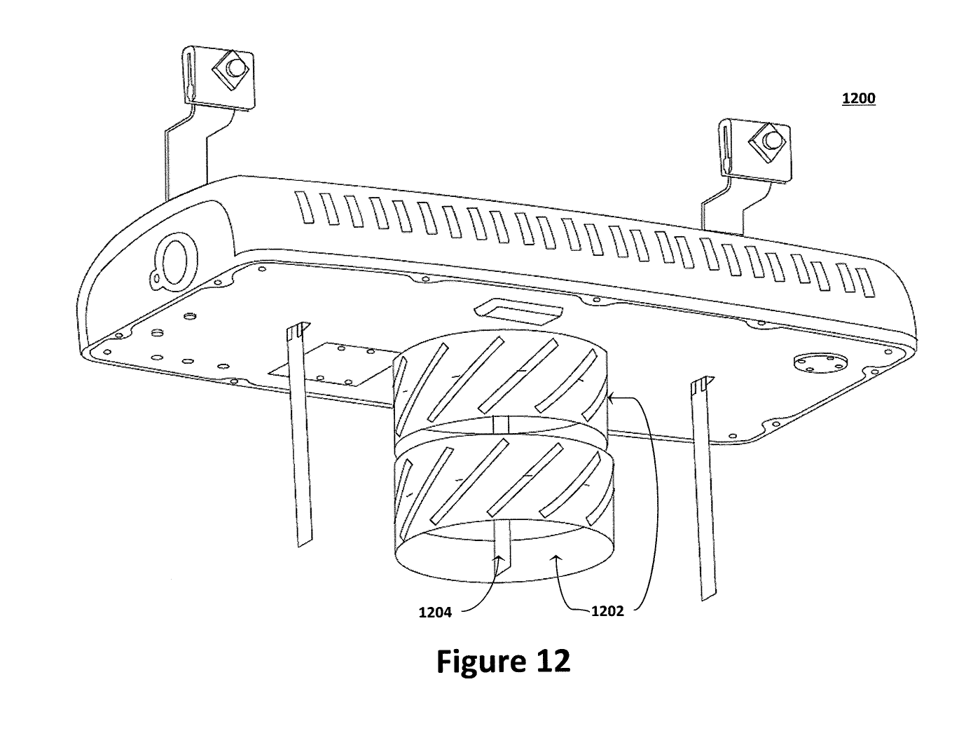

FIG. 12 illustrates a second exemplary dipole smart antenna system 1200 having two cylindrical reflective elements 1204 around a central antenna element 1204, where the reflective elements 1204 are stacked upon one another.

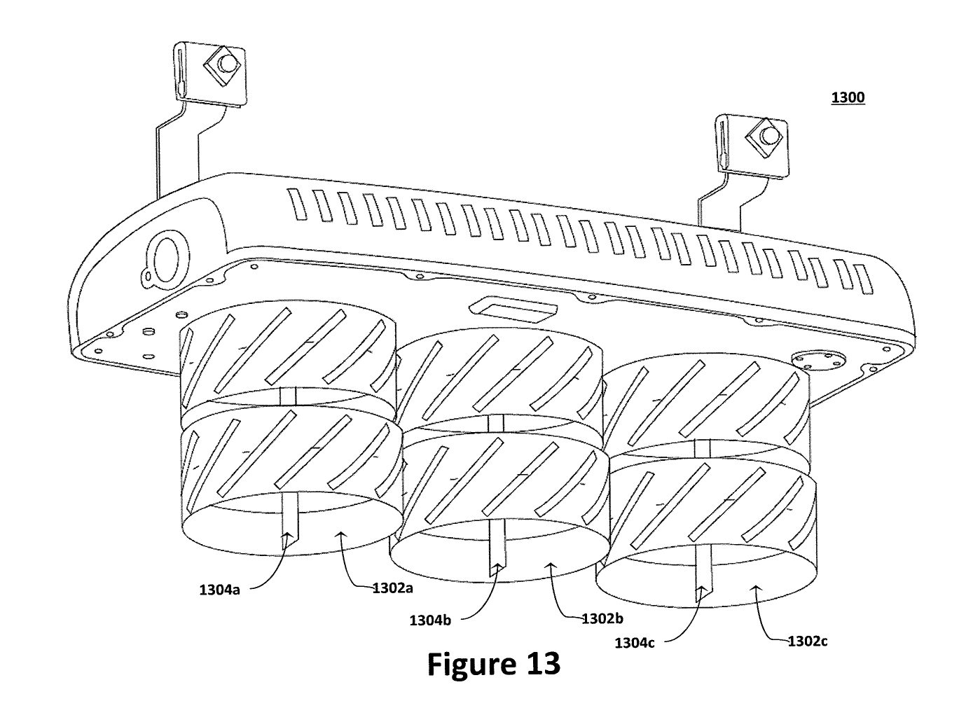

FIG. 13 illustrates a third exemplary dipole smart antenna system 1300 having a total of six large cylindrical reflective elements 1302 around three central antenna elements 1304. As illustrated in the figure, the cylindrical reflective elements 1302 may be stacked around each of the central antenna elements 1304 in sets of two.

Like the antenna systems of FIGS. 11-13, FIG. 14 illustrates a dipole smart antenna system 1400 having three central antenna elements 1404. However, rather than using cylindrical reflective elements, the system 1400 uses a plurality of dipole planar reflective elements arranged into ring-shaped arrays 1402. As illustrated in the diagram, each central antenna elements 1404 may be encircled with one or more stacked dipole arrays 1402, each ring shaped array 1402 having a ground plane 1406 located at the approximate midpoint.

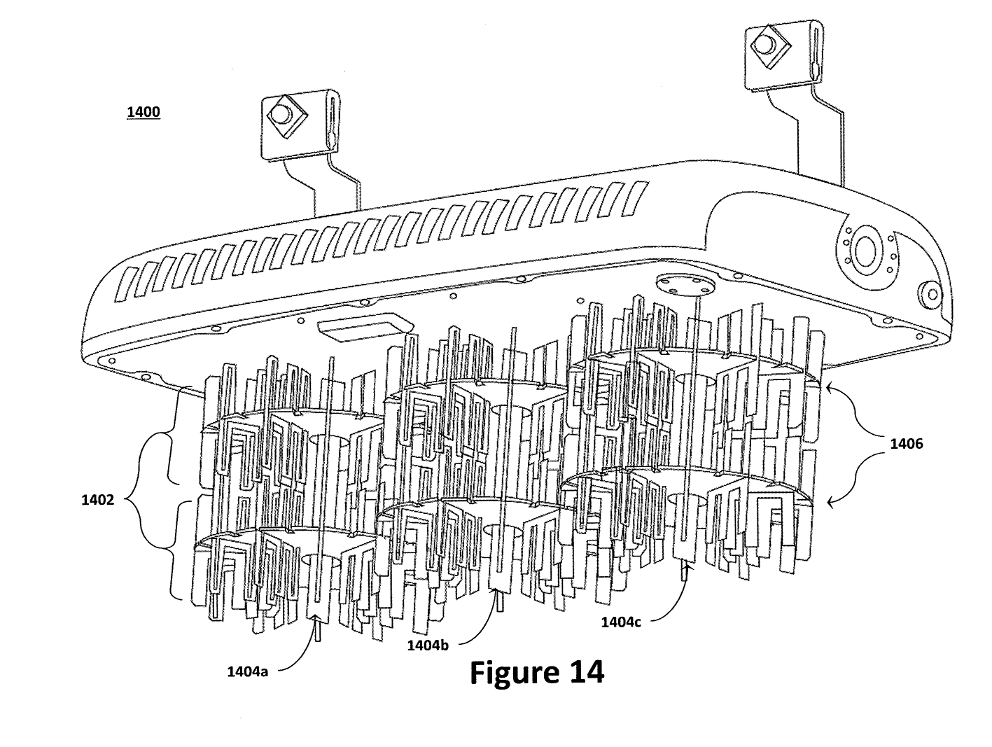

In the configuration of FIGS. 13 and 14, the two outermost rings may be operated at 5 GHz, which are invisible to the 2.4 GHz frequency of the center ring. This transparent parasitic element effect may be accomplished by employing a metamaterial design for the parasitic elements, causing the 2.4 GHz signals to be transparent to the 5 GHz signals. As discussed above, the metamaterial design may be accomplished by using reflector elements comprising both λ/4 long and λ/8 long reflectors, which may appear to the 5 GHz signals as λ/2 and λ/4 elements, respectively. For the 2.4 GHz signals, the λ/8 does not have any effect, but to the 5 GHz signals, these λ/8 reflectors appear at λ/4 reflectors, and that will have the effect of hiding the λ/4 reflectors which appear as λ/2 reflectors to the 5 GHz signals.

Specifically, the systems of FIGS. 13 and 14 comprise a series of three steerable antenna arrays. The first steerable antenna array, having both λ/4 long and λ/8 long reflectors may be operated at a frequency of about 2.4 GHz; the second steerable antenna array having both λ/4 long and λ/8 long reflectors, wherein the second antenna array may be operated at a frequency of about 5 GHz; and the third steerable antenna array, also having both λ/4 long and λ/8 long reflectors and operated at a frequency of about 5 GHz. The first antenna array may be positioned between the second antenna array and the third antenna array wherein the λ/8 reflectors do not have an effect on the 2.4 GHz signals but appear to the 5 GHz signals as λ/4 reflectors, effectively hiding the λ/4 reflectors, which appear as λ/2 reflectors to the 5 GHz signals.

While FIG. 11 through 13 illustrate rings having parasitic elements with a 45 degree right slant, the elements may be installed having a 45 degree left slant. In fact, it may be advantageous to employ both 45 degree left slant and 45 degree right slant to yield dual mode rings or ring sets.

The foregoing smart antennas and/or smart antenna systems may be coupled with, for example, an AP to increase transmission and reception. Referring now to FIG. 15a, each AP 1502 may comprise a processor 1512, power supply 1518, antenna 1516, wired communication link 1514, interface 1518 (e.g., RF transceiver, RF front end, etc.), and storage memory including RAM 1510 and ROM 1508. As depicted in the figure, the AP 1502 may communicate with the client 1520 (e.g., a wireless device) using an over-the-air operation (e.g., via a 802.11 wireless link). While the antenna may be a traditional antenna, it would more preferably be a smart antenna.

Referring now to FIG. 15b, each AP 1502a, 1502b may be configured to communicate with one or more clients 1520 via an over-the-air operation. Similarly, AP 1502a may wirelessly communicate with other APs such as, for example, AP 1502b. To process and manipulate data, the processor 1512b, may be equipped to run software which can be stored to RAM 1510b, ROM 1508b or one or more other computer-readable storage medium. Data collected or created by the AP 1502 may be stored to the RAM 1510b, ROM 1508b, or another suitable storage medium for longer-term retention. Data collected or created by the AP 1502 may also be communicated to another AP 1502, client 1520, or any other device capable of wired or wireless communication. The processor 1512b and other hardware may be powered by power supply 1518b, which may be alternating or direct current (e.g., traditional line current, battery power, solar power, wind power, etc.). In certain embodiments, AP 1502a may communicate with AP 1502b or a client device 1520 using a wired communication link 1514a in addition to, or in lieu of, the antenna 1516a and wireless interface 1518a.

The above-cited patents and patent publications are hereby incorporated by reference in their entirety. Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the invention may therefore be practiced otherwise than as specifically described above.

What is claimed is:

1. A steerable antenna system, comprising:
a dipole antenna element located at substantially the center of a ground plane, wherein the dipole antenna element comprises a first conductor and a second conductor that is oriented parallel and collinear with the first conductor, wherein the ground plane, which has an upper-side and an underside, is located at a point between the first conductor and the second conductor;
a first plurality of parasitic elements, each parasitic element positioned substantially parallel to the dipole antenna element, and arranged on the upper-side of the ground plane in a predetermined array in relation to each other and to the dipole antenna element;
a second plurality of parasitic elements, each parasitic element positioned substantially parallel to the dipole antenna element, and arranged on the underside of the ground plane in substantially the same predetermined array as the first plurality of parasitic elements;
a plurality of switching elements for connecting a parasitic element with a corresponding parasitic element with the ground plane to form reflective elements, wherein the parasitic element and the corresponding parasitic element are oriented parallel and collinear with each other; and
a switching controller for controlling the switching elements, wherein the switching elements are used to alter the antenna system's beam pattern by selectively activating or deactivating said reflective elements.

2. The steerable antenna system of claim 1, wherein the parasitic elements are approximately λ/4 long.

3. The steerable antenna system of claim 1, the first plurality of parasitic elements are approximately ⅜λ long.

4. The steerable antenna system of claim 3, the second plurality of parasitic elements are approximately λ/8 long.

5. The steerable antenna system of claim 1, wherein the reflector elements comprise both reflectors of λ/4 length and reflectors of λ/8 length.

6. The steerable antenna system of claim 1, further comprising a Watson Watts antenna arrangement.

7. The steerable antenna system of claim 1, wherein the plurality of parasitic elements are arranged around the dipole antenna element to form a reflector ring.

8. The steerable antenna system of claim 1, wherein the plurality of parasitic elements are arranged around the dipole antenna element to form two stacked reflector rings.

9. A system having improved signal reception, comprising:
a processor;
data storage;
a wired connection enabled to send and receive a packet;
a wireless connection enabled to wirelessly send and receive a packet;
a dipole antenna element located at substantially the center of a ground plane, wherein the dipole antenna element comprises a first conductor and a second conductor that is oriented parallel and collinear with the first conductor, wherein the ground plane, which has an upper-side and an underside, is located at a point between the first conductor and the second conductor;
a first plurality of parasitic elements, each parasitic element positioned substantially parallel to the dipole antenna element, and arranged on the upper-side of the ground plane in a predetermined array in relation to each other and to the dipole antenna element;
a second plurality of parasitic elements, each parasitic element positioned substantially parallel to the dipole antenna element, and arranged on the underside of the ground plane in substantially the same predetermined array as the first plurality of parasitic elements;
a plurality of switching elements for connecting a parasitic element with a corresponding parasitic element with the ground plane to form reflective elements, wherein the parasitic element and the corresponding parasitic element are oriented parallel and collinear with each other; and
a switching controller for controlling the switching elements, wherein the switching elements are used to alter the antenna system's beam pattern by selectively activating or deactivating said reflective elements.

10. The system of claim 9, wherein the parasitic element are approximately λ/4 long.

11. The system of claim 9, the first plurality of parasitic elements are approximately ⅜λ long.

12. The system of claim 11, the second plurality of parasitic elements are approximately λ/8 long.

13. The system of claim 9, wherein the reflector elements comprise both reflectors of λ/4 length and reflectors of λ/8 length.

14. The system of claim 9, further comprising a Watson Watts antenna arrangement.

15. The system of claim 9, wherein the plurality of parasitic elements are arranged around the dipole antenna element to form a reflector ring.

16. The system of claim 9, wherein the plurality of parasitic elements are arranged around the dipole antenna element to form two stacked reflector rings.

17. A method for dynamically controlling an antenna system, said antenna system having a dipole antenna element, a first plurality of parasitic elements, a second plurality of parasitic elements, a plurality of switching elements for connecting one or more parasitic elements with the a ground plane to form a reflective elements and a switching controller for controlling said switching elements, the method comprising:
scanning a region by steering the antenna system's beam through multiple directions, wherein any interference on a desired channel in measured in each direction;
using the measured interference to create an interference profile, wherein the interference profile is used to identify a most disruptive interference;
determining the direction that corresponds to the most disruptive interference; and
positioning a null in the direction of the most disruptive interference.

18. The method of claim 17, wherein the system positions a null in the direction of the most disruptive interference by rotating the beam pattern.

19. The method of claim 17, wherein the system positions a null in the direction of the most disruptive interference by selectively activating one or more reflective elements.

20. A method for controlling a beam steering antenna system, the antenna system having a dipole antenna element located substantially at the center of a ground plane, a first plurality of parasitic elements located on a first side of the ground plane, a second plurality of parasitic elements on a second side of the ground plane, a plurality of switching elements, and a switching controller, the method comprising:
coupling a parasitic element and a corresponding parasitic element with the ground plane using a switching element, the parasitic element and the corresponding parasitic element being oriented parallel and collinear with each other;
forming a reflective element by triggering the switching element;
using a switching controller to selectively control the switching elements; and
steering a beam by selectively controlling the reflective elements.

21. An steerable antenna system having improved signal reception, comprising:
a first steerable antenna array having both λ/4 long and λ/8 long reflectors, wherein the first steerable antenna array is operated at a frequency of about 2.4 GHz;
a second steerable antenna array having both λ/4 long and λ/8 long reflectors, wherein the second steerable antenna array is operated at a frequency of about 5 GHz; and
a third steerable antenna array having both λ/4 long and λ/8 long reflectors, wherein the third steerable antenna array is operated at a frequency of about 5 GHz,
wherein the first antenna array is positioned between the second antenna array and the third antenna array,
wherein the λ/8 reflectors do not have an effect on the 2.4 Ghz signals and appear to the 5 Ghz signals as λ/4 reflectors, thereby effectively hiding the λ/4 reflectors that appear as λ/2 reflectors to the 5 GHz signals.
